(19) United States
(12) Patent Application Publication
(10) Pub. No.: US 2008/0216634 A1
(43) Pub. Date: Sep. 11, 2008

(54) Construction of a drumshell

(76) Inventor: Wei-Bin Wang, Houli Township (TW)

Correspondence Address: TROXELL LAW OFFICE PLLC, SUITE 1404, 5205 LEESBURG PIKE, FALLS CHURCH, VA, 22041, US

(21) Appl. No.: 11/713,808

(22) Filed: Mar. 5, 2007

(51) Int. Cl. G10D 13/02

(52) U.S. Cl. 84/411 R

(57) ABSTRACT

An improved construction of a drumshell in accordance with the present invention comprises a drumshell 30, ring block 32 and muffling block 33. The invention is to provide an improved construction of a drumshell with specific and unique sound characteristics for playing variety of music.

### BACKGROUND OF THE INVENTION

1. Field of the Invention

The present invention is related to a drumset and more particularly to an improved construction of a drumshell, and adjust the nature resonating or resonating time, so that the drumset having specific and unique sound characteristics for playing variety of music.

2. Description of the Related Art

The present design, mostly the drumshell material comprises by wooden or two sheets are joined to make, when performance, the drumset only can display the single tone color, if want to adjust the timbre, we need other assistance tuning appliance to set it.

The common tuning tone of the method in order to satisfy the different environment, sometimes like live show or in the recording studio, the drumshell having more nature resonating sound to produce reverberation time, and at this time mostly pastes the damping or muffling to change the resonating time, or puts something to absorb high frequency vibration, like the sponge to achieve the special tone or pitch.

In fact, for the user, although above or other tuning method can to set suitable tone color, However, mostly it needs to carry very many tuning appliance along with, It is very inconvenient, also the mostly tuning method makes the adjustment majority in the drumhead or the material of drumshell, but it has limit in adjustment timbre change.

The present invention intends to provide a washer having oil-bearing portions provided on an inner surface to thereby guide the lubricant leaking from a bearing to form a lubricant layer on the end surface of the bearing in such a way to mitigate and overcome the above problem.

### SUMMARY OF THE INVENTION

The primary objective of this invention is to provide an improved construction of a drumshell which the ring block connects a ring socket of the drumshell to change frequency of the sound for adjust the nature resonating.

The secondary objective of this invention is to provide an improved construction of a drumshell which the muffling block connects the connecting socket of the ring block to having Sound absorption effect for adjust the resonating time.

The another objective of this invention is to provide an improved construction of a drumshell with specific and unique sound characteristics for playing variety of music.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is an exploded view of an improved construction of a drumshell in accordance with a first embodiment of the present invention;

FIG. 2 is a perspective view of an improved construction of a drumshell in accordance with the first embodiment of the present invention;

FIG. 3 is a cross-sectional view of an improved construction of a drumshell in accordance with a second embodiment of the present invention;

FIG. 4 is a cross-sectional view of an improved construction of a drumshell in accordance with a third embodiment of the present invention; and

FIG. 5 is a cross-sectional view of an improved construction of a drumshell in accordance with a fourth embodiment of the present invention.

### DETAILED DESCRIPTION OF THE INVENTION

Referring now to the drawings, there are seven embodiments of the present invention shown therein, all of which include generally a primary washer member and a secondary motor member.

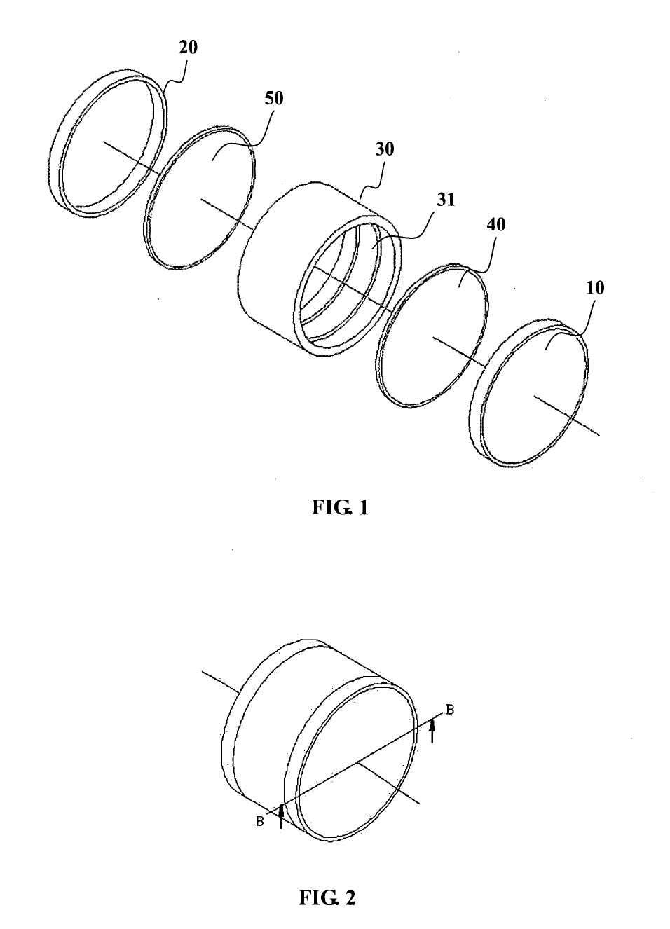

Referring initially to FIGS. 1 and 2, a drumset designated as numeral 1 includes a upper hoop rim as numeral 10, a lower hoop rim as numeral 20, an improved construction of a drumshell as numeral 30, a ring socket as numeral 31, a ring block as numeral 32, a muffling block as numeral 33, a connecting socket as numeral 34, a upper drumhead as numeral 40, and a lower drumhead as numeral 50.

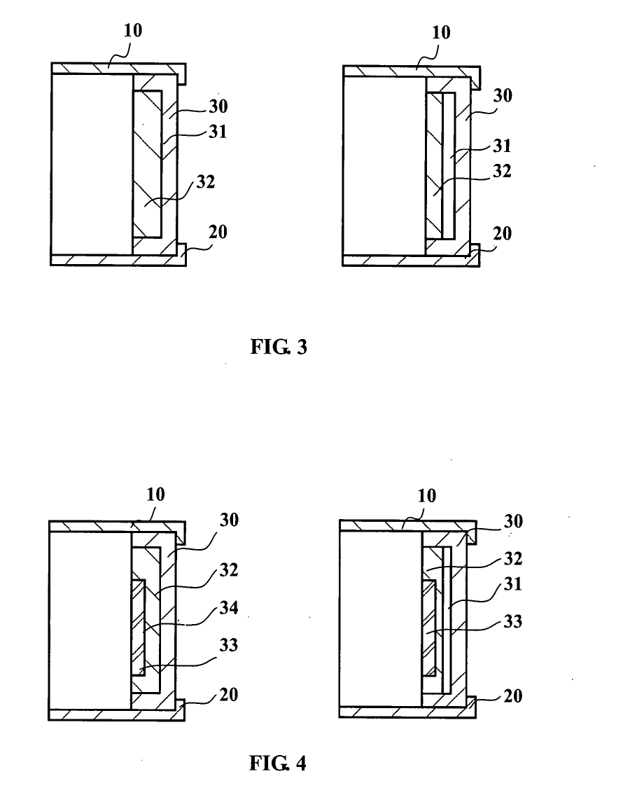

Referring to FIGS. 1 through 3, the pattern in accordance with the first embodiment of the present invention includes a drumshell 30 and ring block 32. The drumshell 30 having a ring socket 31 which is connected with the ring block 32 so that the drumshell 30 and the ring block 32 are able to close state or gap state to change sound frequency of the drumshell for adjust the nature resonating, and the ring socket 31 comprised of a variety of materials, including, for example, wood, steel, carbon fiber and fiberglass.

Referring to FIG. 4, reference numerals of second embodiment of the present invention includes a drumshell 30, ring block 32 and muffling block 33. The ring block 32 having a second connecting socket 34 secured to the muffling block 33, and the muffling block 33 is comprised of variety of materials to reflect and absorption from different frequency pitch to adjust different tone for different performance.

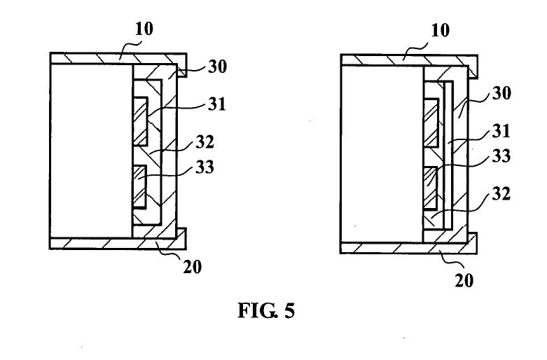

Referring to FIG. 5, reference numerals of third embodiment of the present invention includes a drumshell 30, ring block 32 and muffling block 33, the ring block 30 having a least connecting socket 34 secured to the muffling block 33 for sound attenuating a drumhead with desired acoustic effects.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. An improved construction of a drumshell, comprising:
a drumshell having a ring socket on the inner surface,
a ring block connecting the ring socket to inner surface, and having a connecting socket; and
at least one muffing block connects the connecting socket;
when stuck, the ring block and muffing block is enable the drumshell having Sound absorption effect and adjust the resonating time.

2. An improved construction of a drumshell as defined in claim 1, wherein the ring block material comprises a wood.

3. An improved construction of a drumshell as defined in claim 1, wherein the ring block material comprises a steel.

4. An improved construction of a drumshell as defined in claim 1, wherein the ring block material comprises a fiberglass.

5. An improved construction of a drumshell as defined in claim 1, wherein the ring block material comprises a carbon fiber.

6. An improved construction of a drumshell as defined in claim 1, wherein the ring socket is close state.

7. An improved construction of a drumshell as defined in claim 1, wherein the ring socket is gap state.

8. An improved construction of a drumshell as defined in claim 1, wherein the connecting socket is gap state.

9. An improved construction of a drumshell as defined in claim 1, wherein the connecting socket is gap state.

10. An improved construction of a drumshell as defined in claim 1, wherein the muffing block material comprises a fibrous materials.

11. An improved construction of a drumshell as defined in claim 1, wherein the muffing block material comprises a panel absorber.

12. An improved construction of a drumshell as defined in claim 1, wherein the muffing block material comprises a perforated plate.
